(19) United States
(12) Patent Application Publication
(10) Pub. No.: US 2005/0101688 A1
(43) Pub. Date: May 12, 2005

(54) Polymeric material applicable for making data-recording layer or multi-layer recording medium

(76) Inventors: Wen-Yih Liao, Hsinchu (TW); Huei-Wen Yang, Hsinchu (TW); Ching-Yu Hsieh, Hsinchu (TW); Fu-Hsi Yu, Taipei Hsien (TW); Yu-Hui Cheng, Taipei Hsien (TW)

Correspondence Address: BIRCH STEWART KOLASCH & BIRCH, PO BOX 747, FALLS CHURCH, VA, 22040-0747, US

(21) Appl. No.: 10/771,360

(22) Filed: Feb. 5, 2004

(30) Foreign Application Priority Data
Nov. 7, 2003 (TW) 92131317

(51) Int. Cl. C08J 3/28

(52) U.S. Cl. 522/152

(57) ABSTRACT

A polymeric material applicable for making a data-recording layer of a multi-layer recording medium in the process using a plastic stamper is provided. In the manufacturing process of multi-layer recording media, a plastic substrate carrying data signals is used as a stamper. The stamper includes a plastic substrate formed thereon a signal-carrying layer. The polymeric material is applied on the plastic stamper to form a data-recording layer. The polymeric material has good duplicating characteristics and has different adhesion to a metallic layer and a polymeric layer so that data-recording layer made by the polymeric material is easy to be peeled off from the stamper. The stamper is also reusable for several times so as to save manufacturing cost.

### BACKGROUND OF THE INVENTION

1. Field of the Invention

The invention generally relates to polymeric material applicable for making a data-recording layer of a multi-layer recording medium, and in particular relates to a polymeric material applicable in the manufacturing process of multi-layer recording media, in which a plastic substrate carrying data signals is used as a stamper.

2. Related Art

As the era of information and multimedia comes, the demands on the density and capacities of data recording media for 3C (computer, communication, consumer electronics) products are getting higher and higher. In the field of optical data recording media using laser beam as light source for reading the data, the density of recording is limited to the problem of light diffraction. Now, there have been some methods for increasing the recording density of an optical data-recording medium. For example, advancing the conventional red light laser beam into new blue light laser, or increasing the numerical aperture of the lens. Other methods, such as improvements on digital signal encoding, and the supper-high resolution near-field optics data storage manner, are all effective to improve the storage capacity.

Another technique for improving the storage capacities of optical data recording media is the multi-layer storage method that stores data in multiple layers of the optical media (optical disc) so as to multiply several times of storage capacity. A method for producing multi-layer optical recording medium is disclosed in U.S. Pat. No. 5,059,473. It uses injection molding to get a center substrate having at least one side formed with recesses and protrusions. Recording films are formed on both sides of the substrate and transparent protective plates are bonded to these recording films respectively.

A surface transfer method utilizing the low bonding characteristics of polycyclohexylethylene (PCHE) to aluminum is also applicable. A metallic (such as aluminum) total reflection layer is formed on a high-pressure injection molded PCHE substrate. The total reflection PCHE substrate is then bonded with a photocurable adhesive to a signal-carrying substrate having a semi-reflection layer, and cured through ultraviolet ray. Finally, departing the PCHE substrate from the metallic layer and getting a single-side double layer optical disc substrate. Later, bonding two of this 0.6 mm thickness single-side optical disc substrate into a double-side disc can get a product like a digital video disc (DVD).

The aforesaid two prior methods can produce single-side or double-side multiple layer data-recording medium. However, they require high-pressure injection molding processes that are hard to be improved with their yield rates.

Another process for making a single-side double layer optical disc substrate is disclosed in U.S. Pat. No. 5,171,392. A substrate carrying a first record layer is first sputtered with a reflective layer; adhered to a stamper through a photocurable liquid resin and peeled off to formed a second record layer. Then, applying a second reflective layer to the hardened resin surface opposite the surface in contact with the first reflective layer, and applying a protective layer to the second reflective layer. Also, in U.S. Pat. No. 5,708,652, a photo-curable resin film is interposed between and bonded to a semi-transparent reflective film formed on a first information signal layer and a master disc for transcription of a second information signal layer. The photocurable resin film is then irradiated with light and cured, after which the master disc is peeled off for forming the intermediate layer. These methods all require a metallic master or stamper that is more expensive.

In another example of U.S. Pat. No. 5,874,132, an optical recording medium manufacturing apparatus includes transfer means, a substrate transfer table transferred by the transfer means at a predetermined speed, a drum facing the substrate transfer table and rotating so that the speed of its outer circumferential surface is the same as the speed of a substrate transfer table, a stamp installed on the outer circumferential surface of the drum forming an information recording pit pattern, and resin supply means for injecting molten resin between the stamp and the substrate supported on the table. The process requires good positioning between the stamp and the substrate. Further, the pressure on the substrate is uneven, and the manufacturing of the drum stamp is difficult.

In the above conventional methods, metallic masters are required except for the surface transfer method. While, in the surface transfer method, the PCHE stamper can only be used once and cannot be recycled so that the cost cannot be reduced. The surface transfer method and injection molding can produce one-side multiple (more than two) layer medium substrate. However, they require high pressure molding processes that cause lower yield rate. On the other hand, the methods of U.S. Pat. Nos. 5,171,392; 5,708,652 and 5,874,132 can only produce single-side double layer discs.

As described above, manufacturing processes for producing multi-layer data storing media that have lower costs and higher yield rates are the objects of development. There have been plastic stampers to replace the expensive metallic masters. However, the plastic stampers are not reusable and still cannot reduce the cost.

### SUMMARY OF THE INVENTION

The object of the invention is to provide a polymeric material applicable for making a data-recording layer of a multi-layer recording medium. In the manufacturing process of multi-layer recording media, a plastic substrate carrying data signals is used as a stamper.

A polymeric material according to the invention has different adhesion to a metallic layer and a polymeric layer. The polymeric material has good duplicating characteristics that a data-recording layer made by the polymeric material is easy to be peeled off from the stamper; and the data-recording layer carries fine duplication. The stamper is also reusable for several times so as to save manufacturing cost.

A polymeric material applicable for making a data-recording layer of a multi-layer recording medium according to the invention is composed of an oligomer in 1 to 80 weight percent; a diluent in 1 to 95 weight percent; an adhesive promoter, made of organic and inorganic compound including an element of silicon, phosphorus, titanium, aluminum, sulfonium or chrome, in 0.1 to 10 weight percent; and a photoinitiator in 0.5 to 20 weight percent.

The oligomer in the invention is polyurethane acrylate oligomer having a key chain of urethane bonds and end or side chains of 1 to 10 (meth)acrylate functional groups. The diluent is composed of one or more (meth)acrylate functional monomer. The diluent monomer may also include a functional group of one of hydroxyl, polymeric acid radical, epoxy group and halogen group. The adhesive promoter is chosen from a group of silane coupling agent, titanate coupling agent, zirconate coupling agent and sulfide. The photoinitiator is one chosen from a group of 4-benzoyl-4′-methyl diphonyl sulphide, benzil dimethyl ketal, O-methyl benzoyl benzoate, 1-hydroxy-cyclohexyl-phenyl-ketone, ethyl-4-(dimethylamino) benzoate, 4-methylbenzophenone, methyl 0-benzoyl benzoate, 2-chlorinous thioxanthone, isopropyl thioxanthone, 2-ethylhexyl-4-dimethylaminobenzoate, 2-methyl-1[4-(methylthio)phenyl]-2-morpholinopropan-1-one, 4,4′bis(diethylamino)benzophenone, 2,4,6-trimethylbenzoyl)-phenylphosphineoxide and tribromomethyl lactone.

An alternative composition of the invention is to use phosphorous compound and replace the promoter. The phosphorous compound is a phosphorus vinyl compound or a compound of the following chemical structure:

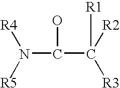

In which R1, R2, R3, R4, R5 are chosen from a group of hydro group, hydroxide group, alky with 1 to 20 carbons, vinyl, cyclene, acrylic and polyether.

A polymeric material applicable for making a data-recording layer in producing a multi-layer recording medium according to the invention can further be added with stabilizer, light-absorbent, interfacial agent and antioxidant, etc.

### BRIEF DESCRIPTION OF THE DRAWINGS

The invention will become more fully understood from the detailed description given hereinbelow. However, this description is for purposes of illustration only, and thus is not limitative of the invention, wherein:

FIGS. 1A to 1H are sequential process diagrams of an embodiment of the invention; and

FIGS. 2A to 2F are sequential process diagrams of applications of the invention for different kinds of optical discs.

### DETAILED DESCRIPTION OF THE INVENTION

The invention provides a polymeric material applicable for making a data-recording layer of a multi-layer recording medium. The stamper includes a plastic substrate formed thereon a signal-carrying layer. The plastic stamper can replace a conventional metallic stamper. The polymeric material of the invention is applied on the plastic stamper to form a data-recording layer so as to save manufacturing cost. The process is also simpler and easy to be automated and improved with higher yield rate.

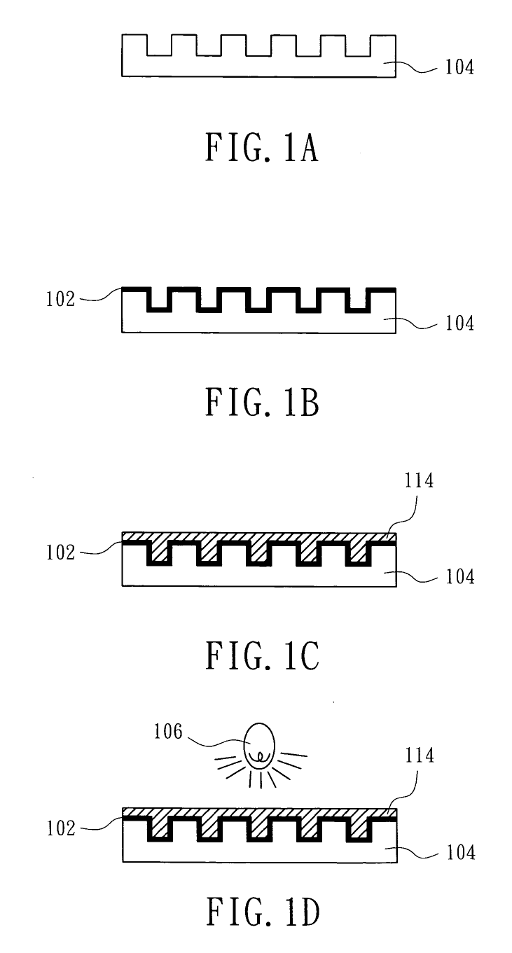

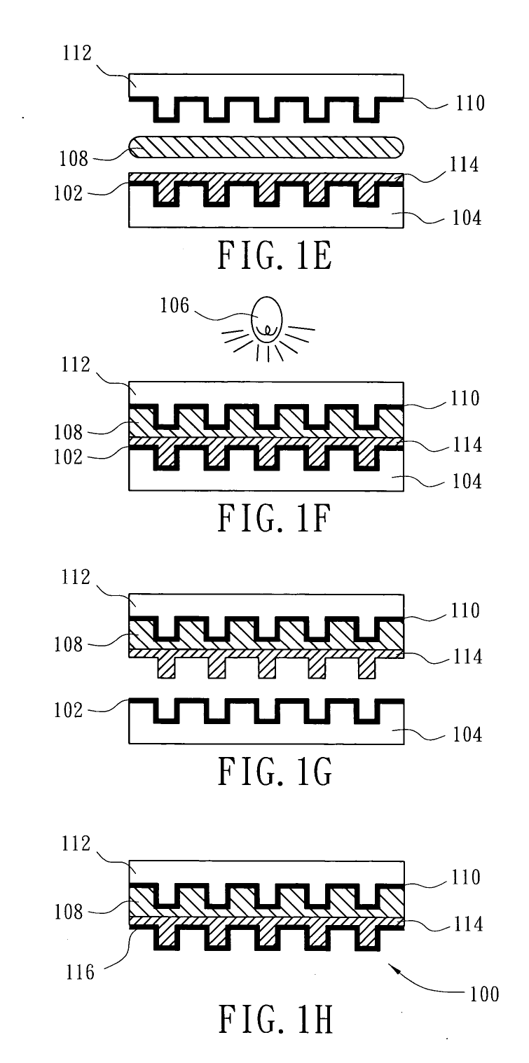

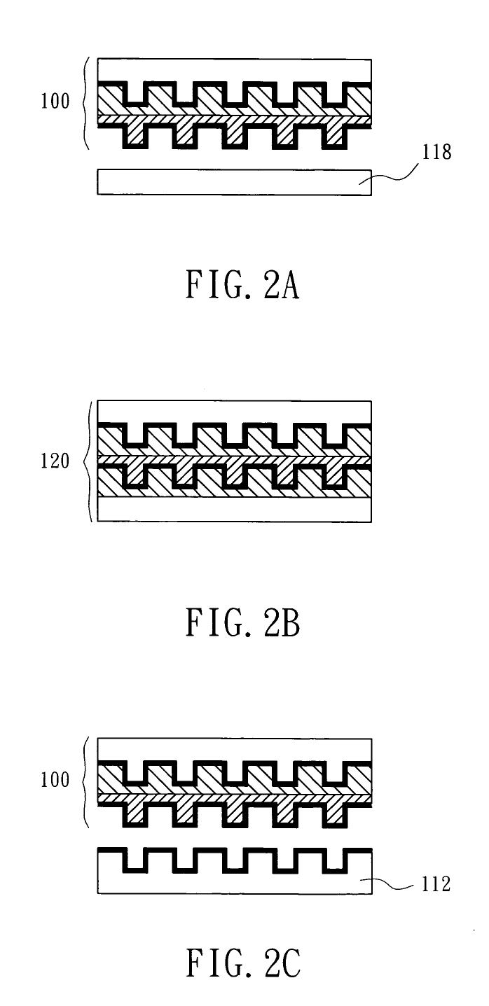

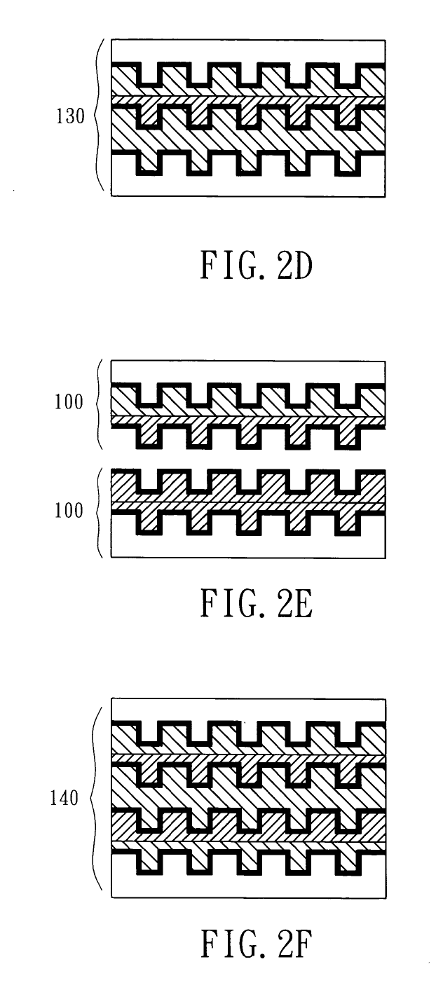

The sequential processes of a preferred embodiment of the invention are shown in FIGS. 1A to 1H. The processes include the following steps. First, providing a substrate 104 (FIG. 1A) having signal pits formed thereon. Forming a 5 to 60 nm thickness signal-carrying layer 102 on the substrate 104 (FIG. 1B) through sputtering. Using spin coating to apply the polymeric material of the invention to form a signal-recording layer 114 on the signal-carrying layer 102. The thickness of the signal-recording layer 114 is controlled within 40 to 65 μm (as shown in FIG. 1C). Applying violet ray to expose and cure the signal-recording layer 114 (as shown in FIG. 1D). Then, applying a layer of the polymeric material to form an adhesive layer 108 for adhering a second substrate 112 that carries signals and being formed with a reflective layer 110 (FIG. 1E). Applying violet ray to expose and cure the adhesive layer 108 (as shown in FIG. 1F). The bonding force between the signal-recording layer 114 and the signal-recording layer 102 is less than that between the signal-recording layer and the adhesive layer 108 so that the signal-recording layer 114 can be departed from the signal-recording layer 102 (FIG. 1G). Sputtering a total reflective layer 116 on top of the signal-recording layer 114 to form a single-side double-layer data-recording medium 100 (FOG. 1H). The invention is applicable for producing different kinds of digital video discs as shown in FIGS. 2A to 2F. By adhering a single-side double-layer data-recording medium 100 with a plain (no signal) polymer substrate 118 (FIG. 2A), a DVD9 disc 120 is obtained (FIG. 2B). By adhering a single-side double-layer data-recording medium 100 with a single signal layer substrate 122 (FIG. 2C), a DVD14 disc 130 is obtained (FIG. 2B). By adhering two single-side double-layer data-recording media 100 (FIG. 2E), a DVD18 disc 140 is obtained (FIG. 2F).

A polymeric material applicable for making a data-recording layer in producing a multi-layer recording medium according to the invention is composed of an oligomer in 1 to 80 weight percent; a diluent in 1 to 95 weight percent; an adhesive promoter, made of organic and inorganic compound including an element of silicon, phosphorus, titanium, aluminum, chrome or sulfur, in 0.1 to 10 weight percent; and a photoinitiator in 0.5 to 20 weight percent.

The oligomer in the invention is polyurethane acrylate oligomer having a key chain of urethane bonds and end or side chains of 1 to 10 (meth)acrylate functional groups. The (meth)acrylate functional groups on the end or side chains come from methacrylate compounds having their hydroxide groups reacting with isocyanate functional groups (N═C═O) on the key or side chains.

The polyurethane acrylate oligomer comes from reaction of polyisocyanate and polyalcohol. The equivalent ratio of the polyalcohol and the polyisocyanate ranges from 0.01 to 0.9 and preferably 0.01 to 0.7. The polyisocyanate is composed of aliphatic or chain aliphatic polyisocyanate, such as one of a group consisting of 1,2 propylene diisocyanate; 1,3 propylene diisocyanate; 1,2 butylene diisocyanate; 1,4 butylene diisocyanate; 5 methylene diisocyanate; 1,6 hexane diisocyanamide; 2,2,4 trimethylene hexane diisocyanamide; duomethylene diisocyanate; 1,3 cyclohexene diisocyanate; 1,4 cyclohexene diisocyanate; methylene 2,4 cyclohexane diisocyanate; methylene 2,6 cyclohexane diisocyanate; 1,3 di(isocyanate methylene)cyclohexane diisocyanate and 1,4 di(isocyanate methylene)cyclohexane diisocyanate.

Another component for producing polyurethane acrylate oligomer is polyalcohol selected from a group consisting of polyester polyalcohol, polyether polyalcohol, polycarbonate polyalcohol and any combination of them. The polyester polyalcohol is an oligomer having esters in the key chain and alcohols at the end or side chains. The polyether polyalcohol is selected from a group consisting of polysulfide polyalcohol, polythylene glycol, polypropylene glycol, polybutylene glycol, polyhexylene glycol, polyhexandiol glycol, polyether polyalcohols having one or more aliphatic alkylamines in the key chain and polyalcohols produced from aforesaid copolymers.

The diluent in the invention is composed of one or more (meth)acrylate functional monomer. The diluent monomer may also include a functional group of one of hydroxyl, polymeric acid radical, epoxy group and halogen group. The adhesive promoter is chosen from a group of silane coupling agent, titanate coupling agent, zirconate coupling agent and sulfide. The photoinitiator is one chosen from a group of 4-benzoyl-4′-methyl diphonyl sulphide, benzil dimethyl ketal, O-methyl benzoyl benzoate, 1-hydroxy-cyclohexyl-phenyl-ketone, ethyl-4-(dimethylamino)benzoate, 4-methylbenzophenone, methyl 0-benzoyl benzoate, 2-chlorinous thioxanthone, isopropyl thioxanthone, 2-ethylhexyl-4-dimethylaminobenzoate, 2-methyl-1[4-(methylthio)phenyl]-2-morpholinopropan-1-one, 4,4′bis(diethylamino)benzophenone, 2,4,6-trimethylbenzoyl)-phenylphosphineoxide and tribromomethyl lactone.

An alternative composition of the invention is to use phosphorous compound and replace the promoter. The compositions of the invention are an oligomer in 1 to 80 weight percent; a diluent in 1 to 95 weight percent; an azotic compound in 0 to 30 weight percent; and a photoinitiator in 0.5 to 20 weight percent. The components of the oligomer, diluent and photoinitiator are the same as described above. The azotic compound is a phosphorus vinyl compound or a compound of the following chemical structure:

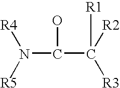

In which R1, R2, R3, R4, R5 are chosen from a group of hydro group, hydroxide group, alky with 1 to 20 carbons, vinyl, cyclene, acrylic and polyether.

A polymeric material applicable for making a data-recording layer in producing a multi-layer recording medium according to the invention can further be added with stabilizer, light-absorbent, interfacial agent and antioxidant, etc.

A polymeric material according to the invention has different adhesion to a metallic layer and a polymeric layer. The polymeric material has good duplicating characteristics that a data-recording layer made by the polymeric material is easy to be peeled off from the stamper; and the data-recording layer carries fine duplication. The stamper is also reusable for more than 30 times so as to save manufacturing cost. The materials of the invention are photopolymers that are violet-curable without the need of air dry or heating of the liquid resin when curing the data recording layers so as to save processes and time of manufacturing.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A polymeric material applicable for making a data-recording layer of a multi-layer recording medium in the process using a plastic stamper, comprising:
an oligomer in 1 to 80 weight percent;
a diluent in 1 to 95 weight percent;
an adhesive promoter, made of organic and inorganic compound including an element selected from a group consisting of silicon, phosphorus, titanium, aluminum, sulfonium and chrome, in 0.1 to 10 weight percent; and
a photoinitiator in 0.5 to 20 weight percent.

2. The polymeric material applicable for making a data-recording layer of a multi-layer recording medium according to claim 1 wherein said oligomer is polyurethane acrylate oligomer having a key chain of urethane bonds and end or side chains of 1 to 10 (meth)acrylate functional groups.

3. The polymeric material applicable for making a data-recording layer of a multi-layer recording medium according to claim 2 wherein said (meth)acrylate functional group in said polyurethane acrylate oligomer comes from methacrylate compounds having hydroxide groups reacting with isocyanate functional groups (N═C═O) on said key or side chains.

4. The polymeric material applicable for making a data-recording layer of a multi-layer recording medium according to claim 2 wherein said polyurethane acrylate oligomer comes from reaction of polyisocyanate and polyalcohol; the equivalent ratio of said polyalcohol and said polyisocyanate ranges from 0.01 to 0.9.

5. The polymeric material applicable for making a data-recording layer of a multi-layer recording medium according to claim 4 wherein said equivalent ratio of said polyalcohol and said polyisocyanate preferably ranges from 0.01 to 0.7.

6. The polymeric material applicable for making a data-recording layer of a multi-layer recording medium according to claim 4 wherein said polyisocyanate is selected from a group consisting of aliphatic polyisocyanate and chain aliphatic polyisocyanate.

7. The polymeric material applicable for making a data-recording layer of a multi-layer recording medium according to claim 4 wherein said polyisocyanate is selected from a group consisting of 1,2 propylene diisocyanate; 1,3 propylene diisocyanate; 1,2 butylene diisocyanate; 1,4 butylene diisocyanate; 5 methylene diisocyanate; 1,6 hexane diisocyanamide; 2,2,4 trimethylene hexane diisocyanamide; duomethylene diisocyanate; 1,3 cyclohexene diisocyanate; 1,4 cyclohexene diisocyanate; methylene 2,4 cyclohexane diisocyanate; methylene 2,6 cyclohexane diisocyanate; 1,3 di(isocyanate methylene) cyclohexane diisocyanate and 1,4 di(isocyanate methylene)cyclohexane diisocyanate.

8. The polymeric material applicable for making a data-recording layer of a multi-layer recording medium according to claim 4 wherein said polyalcohol is selected from a group consisting of polyester polyalcohol, polyether polyalcohol, polycarbonate polyalcohol and a combination thereof.

9. The polymeric material applicable for making a data-recording layer of a multi-layer recording medium according to claim 8 wherein said polyester polyalcohol is an oligomer having esters in the key chain and alcohols at the end.

10. The polymeric material applicable for making a data-recording layer of a multi-layer recording medium according to claim 8 wherein said polyether polyalcohol is selected from a group consisting of polysulfide polyalcohol, polythylene glycol, polypropylene glycol, polybutylene glycol, polyhexylene glycol, polyhexandiol glycol, polyether polyalcohols having at least an aliphatic alkylamines in the key chain and polyalcohols produced from said copolymers.

11. The polymeric material applicable for making a data-recording layer of a multi-layer recording medium according to claim 1 wherein said diluent is composed of at least a (meth)acrylate functional monomer.

12. The polymeric material applicable for making a data-recording layer of a multi-layer recording medium according to claim 1 wherein said diluent monomer is selected from a functional group consisting of hydroxyl, polymeric acid radical, epoxy group and halogen group.

13. The polymeric material applicable for making a data-recording layer of a multi-layer recording medium according to claim 1 wherein said adhesive promoter is selected from a group consisting of silane coupling agent, titanate coupling agent, zirconate coupling agent and sulfide.

14. The polymeric material applicable for making a data-recording layer of a multi-layer recording medium according to claim 1 wherein said photoinitiator is selected from a group consisting of 4-benzoyl-4′-methyl diphonyl sulphide, benzil dimethyl ketal, O-methyl benzoyl benzoate, 1-hydroxy-cyclohexyl-phenyl-ketone, ethyl-4-(dimethylamino) benzoate, 4-methylbenzophenone, methyl 0-benzoyl benzoate, 2-chlorinous thioxanthone, isopropyl thioxanthone, 2-ethylhexyl-4-dimethylaminobenzoate, 2-methyl-1[4-(methylthio)phenyl]-2-morpholinopropan-1-one, 4,4′bis(diethylamino)benzophenone, 2,4,6-trimethylbenzoyl)-phenylphosphineoxide and tribromomethyl lactone.

15. The polymeric material applicable for making a data-recording layer of a multi-layer recording medium according to claim 1 further comprises an additive selected from a group of stabilizer, light-absorbent, interfacial agent and antioxidant.

16. A polymeric material applicable for making a data-recording layer of a multi-layer recording medium in the process using a plastic stamper, comprising:
an oligomer in 1 to 80 weight percent;
a diluent in 1 to 95 weight percent;
an azotic compound in 0 to 30 weight percent; and
a photoinitiator in 0.5 to 20 weight percent.

17. The polymeric material applicable for making a data-recording layer of a multi-layer recording medium according to claim 16 wherein said oligomer is polyurethane acrylate oligomer having a key chain of urethane bonds and end or side chains of 1 to 10 (meth)acrylate functional groups.

18. The polymeric material applicable for making a data-recording layer of a multi-layer recording medium according to claim 17 wherein said (meth)acrylate functional group constructed in said polyurethane acrylate oligomer comes from methacrylate compounds having hydroxide groups reacting with isocyanate functional groups (N═C═O) on said key or side chains.

19. The polymeric material applicable for making a data-recording layer of a multi-layer recording medium according to claim 16 wherein said polyurethane acrylate oligomer comes from reaction of polyisocyanate and polyalcohol; the equivalent ratio of said polyalcohol and said polyisocyanate ranges from 0.01 to 0.9.

20. The polymeric material applicable for making a data-recording layer of a multi-layer recording medium according to claim 19 wherein said equivalent ratio of said polyalcohol and said polyisocyanate preferably ranges from 0.01 to 0.7.

21. The polymeric material applicable for making a data-recording layer of a multi-layer recording medium according to claim 19 wherein said polyisocyanate is selected from a group consisting of aliphatic polyisocyanate and chain aliphatic polyisocyanate.

22. The polymeric material applicable for making a data-recording layer of a multi-layer recording medium according to claim 19 wherein said polyisocyanate is selected from a group consisting of 1,2 propylene diisocyanate; 1,3 propylene diisocyanate; 1,2 butylene diisocyanate; 1,4 butylene diisocyanate; 5 methylene diisocyanate; 1,6 hexane diisocyanamide; 2,2,4 trimethylene hexane diisocyanamide; duomethylene diisocyanate; 1,3 cyclohexene diisocyanate; 1,4 cyclohexene diisocyanate; methylene 2,4 cyclohexane diisocyanate; methylene 2,6 cyclohexane diisocyanate; 1,3 di(isocyanate methylene) cyclohexane diisocyanate and 1,4 di(isocyanate methylene)cyclohexane diisocyanate.

23. The polymeric material applicable for making a data-recording layer of a multi-layer recording medium according to claim 19 wherein said polyalcohol is selected from a group consisting of polyester polyalcohol, polyether polyalcohol, polycarbonate polyalcohol and a combination thereof.

24. The polymeric material applicable for making a data-recording layer of a multi-layer recording medium according to claim 23 wherein said polyester polyalcohol is an oligomer having esters in the key chain and alcohols at the end.

25. The polymeric material applicable for making a data-recording layer of a multi-layer recording medium according to claim 23 wherein said polyether polyalcohol is selected from a group consisting of polysulfide polyalcohol, polythylene glycol, polypropylene glycol, polybutylene glycol, polyhexylene glycol, polyhexandiol glycol, polyether polyalcohols having at least an aliphatic alkylamines in the key chain and polyalcohols produced from said copolymers.

26. The polymeric material applicable for making a data-recording layer of a multi-layer recording medium according to claim 16 wherein said diluent is composed of at least a (meth)acrylate functional monomer.

27. The polymeric material applicable for making a data-recording layer of a multi-layer recording medium according to claim 16 wherein said diluent monomer is selected from a functional group consisting of hydroxyl, polymeric acid radical, epoxy group and halogen group.

28. The polymeric material applicable for making a data-recording layer of a multi-layer recording medium according to claim 16 wherein said azotic compound is a phosphorus vinyl compound.

29. The polymeric material applicable for making a data-recording layer of a multi-layer recording medium according to claim 16 wherein said azotic compound is a compound of the following chemical structure:

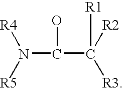

30. The polymeric material applicable for making a data-recording layer of a multi-layer recording medium according to claim 29 wherein R1, R2, R3, R$, R5 are selected from a group of hydro group, hydroxide group, alky with 1 to 20 carbons, vinyl, cyclene, acrylic and polyether.

31. The polymeric material applicable for making a data-recording layer of a multi-layer recording medium according to claim 16 wherein said photoinitiator is selected from a group consisting of 4-benzoyl-4′-methyl diphonyl sulphide, benzil dimethyl ketal, O-methyl benzoyl benzoate, 1-hydroxy-cyclohexyl-phenyl-ketone, ethyl-4-(dimethylamino) benzoate, 4-methylbenzophenone, methyl 0-benzoyl benzoate, 2-chlorinous thioxanthone, isopropyl thioxanthone, 2-ethylhexyl-4-dimethylaminobenzoate, 2-methyl-1[4-(methylthio)phenyl]-2-morpholinopropan-1-one, 4,4′bis(diethylamino)benzophenone, 2,4,6-trimethylbenzoyl)-phenylphosphineoxide and tribromomethyl lactone.

32. The polymeric material applicable for making a data-recording layer of a multi-layer recording medium according to claim 16 further comprises an additive selected from a group of stabilizer, light-absorbent, interfacial agent and antioxidant.
